(19) United States
(12) Patent Application Publication
(10) Pub. No.: US 2009/0145916 A1
(43) Pub. Date: Jun. 11, 2009

(54) FOOD CONTAINER SYSTEM WITH HANDLE STRAP

(75) Inventors: IRA MAROOFIAN, Woodland Hills, CA (US); Leon Derrick Farahnik, Los Angeles, CA (US)

Correspondence Address: KNOBBE MARTENS OLSON & BEAR LLP, 2040 MAIN STREET, FOURTEENTH FLOOR, IRVINE, CA, 92614, US

(73) Assignee: PWP Industries, Inc., Vernon, CA (US)

(21) Appl. No.: 12/329,359

(22) Filed: Dec. 5, 2008

Related U.S. Application Data
(60) Provisional application No. 61/012,018, filed on Dec. 6, 2007.

(51) Int. Cl. B65D 25/28; B23P 19/04

(52) U.S. Cl. 220/752; 29/700

(57) ABSTRACT

The food container system can comprise a lid, tray, and strap. The strap can comprise signage, a handle, and two attachment ends on the sides of the handle. The signage can convey information to a user concerning certain product information and/or other information.

### PRIORITY INFORMATION

This application claims the priority benefit under 35 U.S.C. § 119(e) to U.S. Provisional Patent Application Ser. No. 61/012,018 (filed Dec. 6, 2007), the entirety of which is hereby expressly incorporated by reference herein.

### BACKGROUND

1. Field of the Invention

The present invention relates to a food container system and, more particularly, to a food container system with a handle.

2. Description of the Related Art

Many food vendors do not distribute their food products in open dishes such as open plates or bowls. Instead, the food products are typically provided in a sealed package. Rigid and flexible plastic containers can be used to protect and display both perishable and fragile food items such as sandwiches, salads and bakery items. These roles of plastic packaging can be expanded to meet additional demands. Presentation, brand presence, consumer desires, added value to enhance commercial competitiveness, differentiation, imagery and psychology can all be factors in package design and application. Convenience and versatility continue to shape the future of packaging, with consumers gravitating toward packaged convenience items. Thus, social and environmental considerations can be advantageously included in the development process of plastic packaging. The provision of multiple compartments in a variety of shapes and utilities in rigid plastic containers is an example of a useful advantage.

Rigid plastic food containers can be manufactured from Polystyrene, Polypropylene, Polyethylene Terephthalate (PET), Polylactide, Polyvinyl Chloride (PVC), or other rigid polymers. They can comprise multiple parts—e.g., a tray and lid—or they may be a one-piece construction with a hinge that allows one portion of the container to act as the tray and the other connected portion to act as a lid. Plastic packages can be manufactured in a variety of shapes and cross-sections: circular, rectangular, square, elliptical, etc.

The use of such plastics for holding heated food has many advantages, especially with rotisserie chicken applications. However, many currently available food packages have not been designed to cater to the consumer's needs, for example, as related to the handling of container systems for heated foods. Heating of the container contents can result in high temperature fluids and gases, increased pressure build-up, and so forth. A hot container can thus be painful to touch. Such constraints also place limitations on the logistical elements such as containerization of large quantities of heated food product.

### SUMMARY OF THE INVENTION

The inventions described herein provide a variety of benefits over the prior art. For example, the containers described herein can include superior handling structures for consumers. Additionally, the containers can have a compact design that is easily stackable into columns and/or rows for storage and transport. The container can have a design that is both stackable when holding product, and when empty (sometimes in an open configuration). Further, the containerization solutions can include modular elements, adding to the versatility of the container systems described. This disclosure provides for a unique approach that achieves these objectives, among others.

Accordingly, disclosed herein are embodiments of container systems with handles for food containers. In one embodiment, a food packaging containment system is suitable for heated food items such as rotisserie chicken and the like, and includes a tray compartment, a lid member and a handle.

In further embodiments, the container system can include a plastic tray, a lid, and a flexible strap. The tray can have an upper surface and a lower surface, and the upper surface can define a recess surrounded by a rim. The lid can releasable couple to the tray, and can also or alternatively define a recess surrounded by a rim. The flexible strap can include a handle portion, a first attachment portion, and a second attachment portion. The attachment portions can be at opposite ends of the handle portion, and couple to opposite sides of the lower surface of the tray. The strap can further extend over the lid.

In another embodiment, a tray can support the entire weight of a contained item. The lid can attach to the tray by a releasably lockable snap-fit grip, which is strong enough to support the entire weight of the contained item and the tray. The flexible strap can couple to the lid, and include two end portions surrounding a handle portion.

In yet another embodiment, a method of assembling a food container is provided. Food can be placed into a recess of a tray portion of the food container. A lid portion can be coupled to the tray portion by engaging the lid and tray in a snap fit to enclose the food item. A flexible strap can be extended over the lid and coupled to a lower surface of the tray portion to form a handle extending over the lid.

For purposes of contrasting various embodiments with the prior art, certain aspects and advantages of these embodiments are described above. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein. The systems and methods discussed herein can be used anywhere.

### BRIEF DESCRIPTION OF THE DRAWINGS

The following drawings and the associated descriptions are provided to illustrate embodiments of the present disclosure and do not limit the scope of the disclosure or claims.

FIG. 1 is a top and side perspective view of an embodiment container system comprising a lid, a tray and strap.

FIG. 2 is a top and side perspective view of the container system showing a disassembled lid and tray without the strap.

FIG. 3 is a top view of the strap of FIG. 1.

FIG. 4 is a side view of the container system of FIG. 1.

FIG. 5 is a top view of the container system of FIG. 1.

FIG. 6 is a sectional view along section 6-6 of FIG. 5.

FIG. 6A is a sectional view as that of FIG. 5 showing another embodiment of the strap.

FIG. 7 is a front view of the container system of FIG. 3.

FIG. 8 is a top and side perspective view of another embodiment of the container system showing the lid, tray and strap.

### DETAILED DESCRIPTION OF PREFERRED EMBODIMENTS

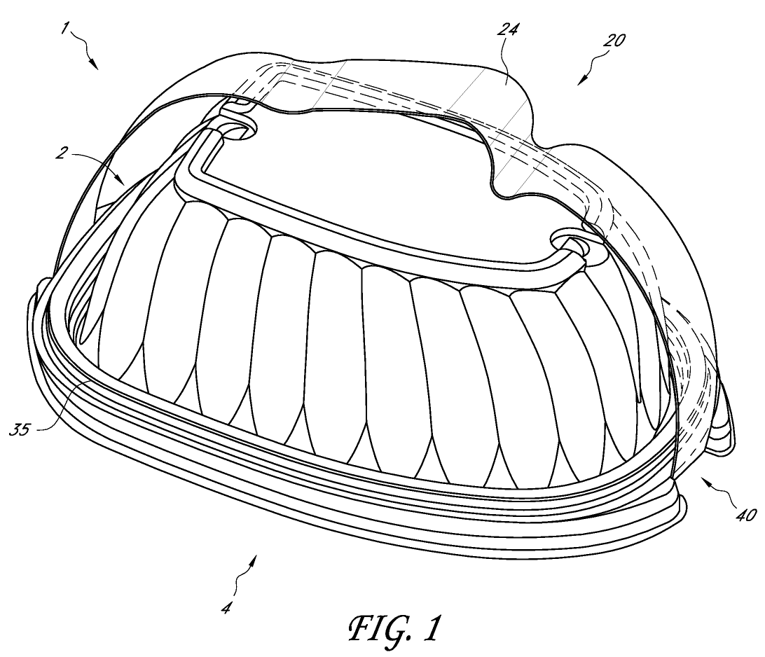

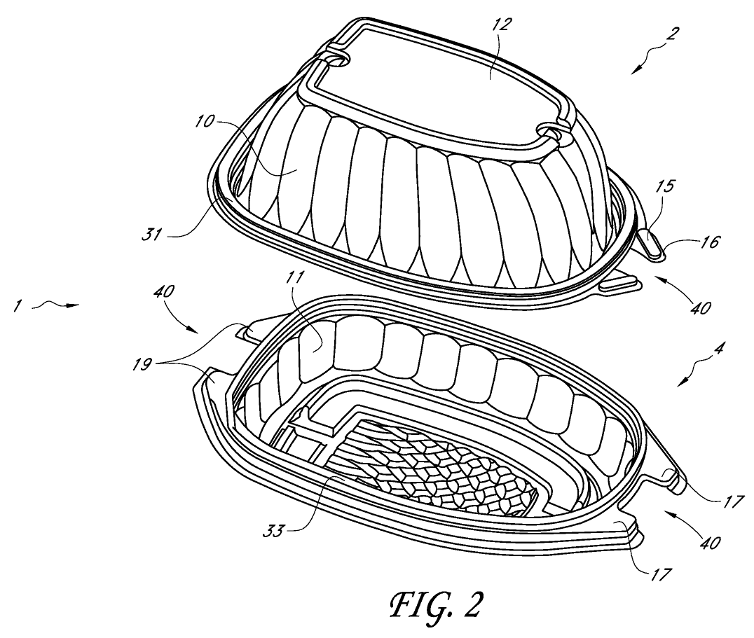

FIG. 1 illustrates one embodiment of a dome-shaped, rigid polymer construct food container system 1 having certain features and advantages according to the present invention. In the illustrated embodiment, the food container system 1 includes a lid 2 and tray 4, which are shown separated in FIG. 2. With reference to FIG. 2, the tray 4 can form the primary recess into which heated food items, such as a rotisserie chicken, is placed. The lid 2, in turn, can be generally domed shape and is configured to extend over and around the item placed in the tray 4. In one embodiment, the lid 2 is generally transparent while the tray 4 is not.

As depicted, the lid 2 and tray 4 can have a slightly elongated shape, defining a major and minor axis. As described herein, the major axis refers to the longer axis of the lid 2 and tray 4 and extends in a “longitudinal direction.” As described herein, the minor axis refers to the shorter axis of the lid 2 and tray 4 and extends in a “lateral direction.” Finally, as described herein, the height of the lid 2 and tray 4 corresponds to a “vertical axis” and a “vertical direction” depicted as being perpendicular to the major and minor axes/directions. However, it should be appreciated that in modified embodiments the lid 2 and tray 4 can have different shapes (e.g., round, square, rectangular etc.).

The depicted embodiments of the lid 2 and tray 4 include rims 31, 33 that extend around the domed portions and recess formed by the lid 2 and tray 4 respectively. The rims 31, 33 can generally match, such that the lid 2 and tray 4 form a closed chamber when combined. Further, as described below the rims 31, 33 can form various sealing mechanisms for connecting the lid 2 and tray 4 together. Further, as depicted the lid 2 includes a top surface 12.

The lid 2 and tray 4 of the container system 1 can be molded, through thermoforming manufacturing techniques, from a single sheetline of polymer material work piece into a predetermined shape and thickness as required. The lid 2 and tray 4 of the container system 1 may also be formed, through known thermoforming manufacturing techniques, into a curvilinear geometry to thereby provide the end user with a variety of polygonal shapes.

With continued reference to FIGS. 1 and 2, the lid 2 can further include a handhold 15, which, in the illustrated embodiment, extends across the longitudinal axis of the lid 2. In the illustrated embodiment, only single handhold 15 is illustrated on the lid 2 but in other embodiments more handholds can be included, the handhold can be eliminated or positioned in a different location. Similarly, the tray 4 can include a pair of handholds 17, 19, positioned on opposite sides of the tray along its longitudinal axis. As with the lid 2, the tray can include more or fewer handholds in different positions. The handholds 15, 17, 19 can include rib elements 16 (depicted on only the lid handhold 15) to increase their rigidity and strength. A user can then carry the container system 1 using the handholds 15, 17, 19 and further pull the handholds apart to release any locking mechanisms between the lid 2 and tray 4 to open the container system 1. To prevent damage to the container system 1 and increase the strength of these components, the sidewalls of the lid 2 and tray 4 can additionally include ribbing 10, 11.

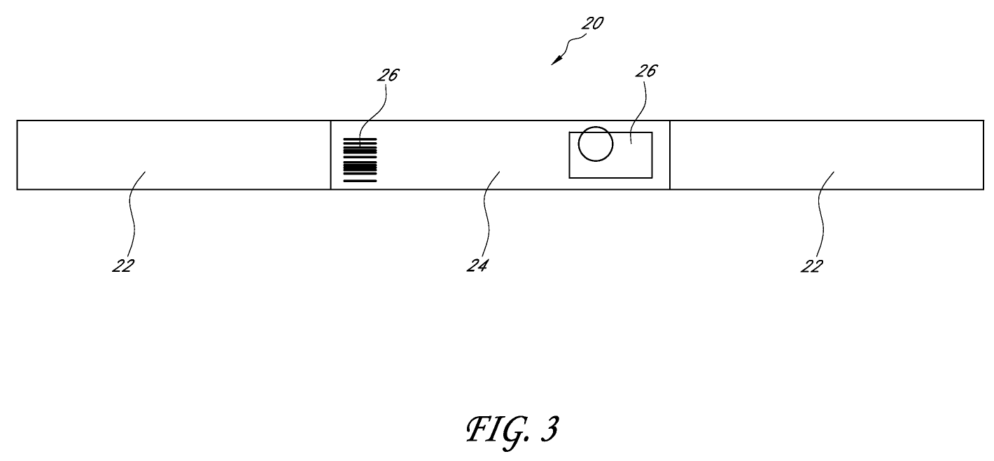

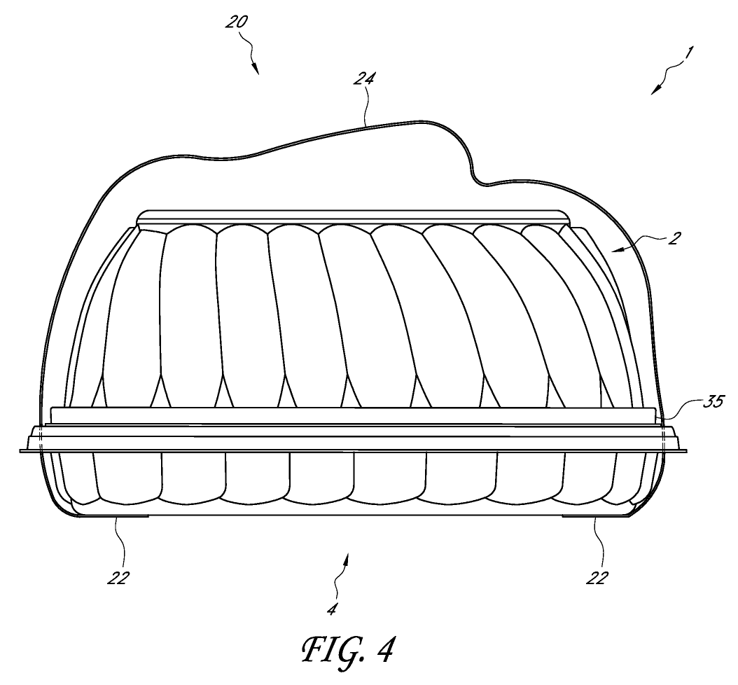

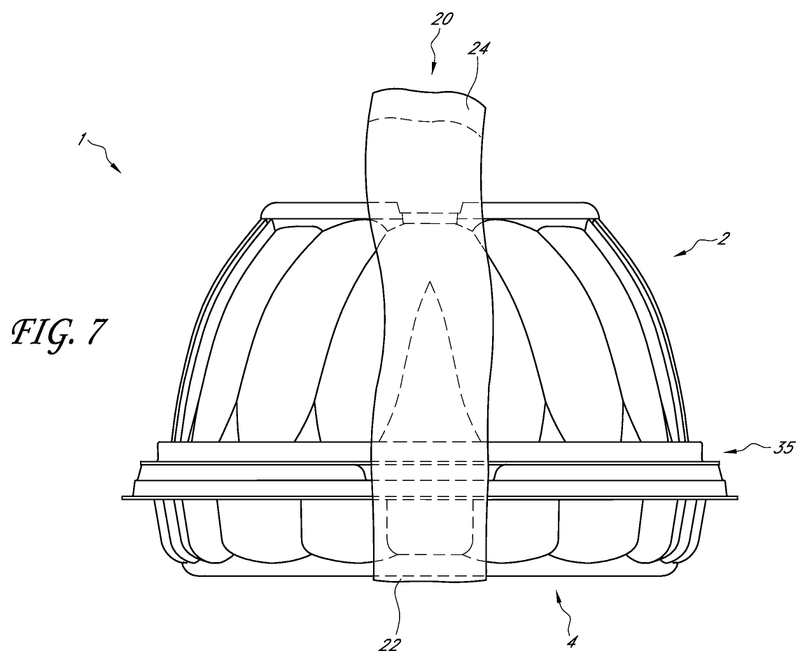

FIG. 3 illustrates a preferred embodiment of a strap 20 that can be used with the food container system 1 of FIGS. 1-2, 4-7. As illustrated, the strap 20 comprises a pair of attachment ends 22 and a handle 24 between the attachment ends 22. The strap 20 can advantageously be made of paper or plastic or some combination of both. In a preferred embodiment, the strap 20 is flexible. The attachment ends 22 are configured to attach to the food container system 1 as will be explained below. In one embodiment, the attachment ends 22 may comprise paper or plastic with an adhesive, or with glue. In another embodiment, the attachment ends 22 are attached with a separate component, such as, for example, plastic tape. The attachment ends 22 can attach the strap 20 to the lid 2 and/or tray 4 of the container system 1.

The handle 24 is advantageously not sticky to the touch. Accordingly, in one embodiment, the handle 24 may comprise tape and a paper backing. As shown in FIG. 1, the handle 24 provides a user a place to hold the container system 1. The handle 24 allows the user to hold the container system 1 while the handle and the user's hand are displaced a set distance away from the container system 1 itself, which allows the container system 1 to be more easily handled even when exceptionally hot or cold foods are placed inside.

The strap 20 can be coupled to the container 1 in numerous ways. For example, the strap 20 can be initially permanently attached (e.g., heat bonded, ultrasonic welding, etc.) to the container system 1 at one end, and the other end can then adhere to the container system 1 on an opposite side. In other embodiments, the strap 20 can be initially permanently attached at both ends, or alternatively can initially come separate from the container system 1. Where the strap 20 is at least partially initially attached, the strap 20 can be initially folded into a compact position, facilitating stacking.

Where the strap 20 is initially separated, the modularity of the strap provides a wider variety of design options. In some embodiments, the strap 20 can be printable, allowing a vender to easily provide varying signage 26 (see FIG. 3). The signage 26 allows a user, such as a grocer, to easily place information on the container system. The information may consist of one or more of the following examples: advertising, branding, ingredients, product information, uniform product code (UPC), warranty details, nutritional information, etc. The signage 26 may be printed directly on the strap 20 or it may be attached to the strap 20 by other means, such as by a sticker. The signage 26 may also include a combination of printed information and stickers. The illustrated embodiment in FIG. 3 shows signage 26 on the handle 24 consisting of branding and a UPC. In another embodiment the signage 26 may be on the attachment ends 22 or it may be on both the handle 24 and the attachment ends.

The attachable strap 20 provides many benefits. For example, for a store or grocer, the strap 20 can be used on different types of container systems or only on similar types of containers. Additionally, the strap signage 26 may vary such that it can be used on different products, such as with chicken or fish, or the signage 26 may give specific product details such as weight, price, or date. Even more, the signage 26 may be varied among products to differentiate brands or even flavors and styles of the same product.

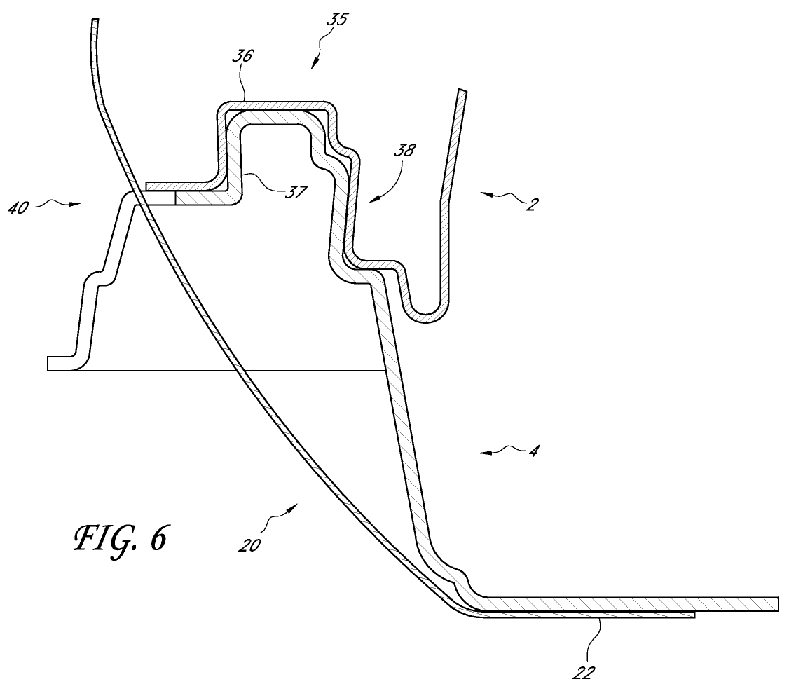

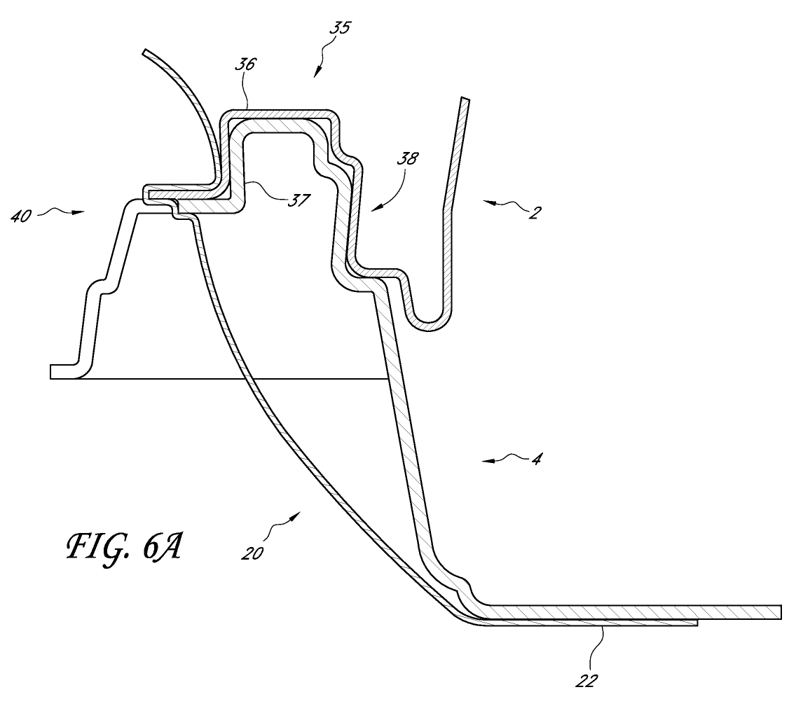

The strap 20 may provide the additional benefit of sealing the container system shut. For example, the attachment ends 22 may comprise tape and the tape may be sufficiently long so as to go over a portion of both the lid 2 and tray 4. Further, in some embodiments, the lid 2 and/or tray 4 can include their own adhesive at pre-designated attachment regions. Additionally, in some embodiments the strap 20 can adhere to the lid 2 and tray 4 in regions substantially adjacent the seam between the lid and tray, as depicted in FIG. 6A (further described below).

In some embodiments, the strap 20 can form a tamper-evident feature wherein the strap 20 will break when attempting to open the container system 1. For example, when the strap 20 attaches to both the lid 2 and tray 4, and is sufficiently tight between the lid and tray, the strap must break if the two are separated. A broken strap 20 can thus indicate prior entry, and an intact strap can indicate preserved freshness. Accordingly, the strap 20 can potentially provide the multiple functionality of: (1) facilitating handling of the container system 1, (2) providing signage, and (3) reliably sealing the contents. However, it will be clear from the description herein that the illustrated embodiment of the strap 20 can provide even further advantages and in other embodiments can include only one or sub-combination of these futures.

For the ultimate consumer, the strap 20 provides a handle 24 that allows the user to carry the container 1 without coming into contact with exceptionally hot or cold portions. The grocer is able to provide these additional benefits without compromising on shelf space as the strap 20 is preferably thin and takes up minimal space. Other benefits and advantages of the strap will be apparent to those skilled in the art.

In some embodiments, suitable for a chicken roaster, the strap 20 is approximately 23 inches long and one and one half inches wide, with the signage 26 comprising eleven inches in length, approximately centered on the strap 20. The strap 20 may take on many different sizes and dimensions and the size may be optimized depending on various criteria such as the size of the food container system to which it will be attached. For example, in embodiments where the strap 20 is configured to provide more stable handling, the strap can be wider at the attachment ends 22 and narrower in the handle portion.

Further facilitating handling, the strap 20 is depicted stretching over the major axis of the lid 2 and tray 4. Providing the strap 20 along the major axis can minimize the rotational inertia of the container system 1 about the strap. However, in other embodiments the strap 20 can be provided along another axis, for example where other design concerns take precedence or where the weight in the container system 1 is distributed primarily over a minor axis. In further embodiments, the strap 20 can extend across a diagonal of the lid 2 and tray 4, spanning a hypotenuse of the major and minor axes.

The strap 20 of the preferred embodiment is also advantageously inexpensive to manufacture. The strap 20 can be made of simple construction, but can also include a variety of features as described herein. As explained above, the strap 20 can be formed from a strong paper strip with adhesive or glue forming the attachment ends 22. Additionally, the strap 20 can be a sticker with a paper backing at the handle 24. The strap 20 can also be made inexpensively utilizing a multiple piece construction. For example, a paper handle can attach to the container system with separate stickers as the attachment ends 22.

With reference back to FIG. 1, in the illustrated embodiment, the food container system 1 further comprises at least one guiding portion 40. The guiding portion 40 facilitates attachment of the strap 20 to the tray 4 and/or lid 2. The guiding portion 40 is configured to inform a user of an optimal location to attach the strap 20. The guiding portion 40 may additionally allow the strap 40 to be attached more closely to the center of mass of the container system 1 to increase the ease of use for the user. As best depicted in FIG. 1, the strap 20 is close to the center of mass along the longitudinal dimension. In other embodiments the strap 20 can be placed close along the lateral dimensions or vertical dimensions. Along the lateral dimension, an additional or alternative strap 20 can be provided. Along the vertical dimension, the center of mass can be supported by attaching the strap(s) 20 at the appropriate vertical height.

In some embodiments, the guiding portion 40 comprises at least one notch in the container system 1; but in other embodiments the guiding portion 40 can take other forms such as an aperture or groove. The at least one notch may be in the form of a preformed notch, a slot, or a cutaway section. The at least one notch is preferably located along a sealing engagement portion of the container system 1, wherein the sealing engagement portion comprises an area in which the lid 2 and tray 4 are sealingly engaged. In the illustrated embodiment of FIGS. 1-7, the guiding portion 40 can comprise a recess in the grips 16, 17 19. In these embodiments the grocer is informed of the optimal location for the strap 20 by the clear recess in the grips 16, 17 and 19. This configuration also allows the strap 20 to remain in close proximity to the tray 4 and lid 2, thus increasing stability and ease of use. In other embodiment, the guiding portion 40 can be formed by an aperture or opening in the grips 16, 17, 19. However, in alternative embodiments the guiding portion 40 can be formed in one or both of the rims 31, 33, away from the grips 16, 17, 19. Separating the grips 16, 17, 19 from the guiding portion 40 can in some embodiments allow for the grips to have a larger size (as they do not include a aperture/opening/etc. for the guiding portion). Nevertheless, in other embodiments it may be preferred to include both the guiding portion 40 and the grips 16, 17, 19 along the major axis, for enhanced stability and leverage, respectively. In other embodiments, one, more or all of the grips 16, 17 can be eliminated. In some embodiments, it is also anticipated that guiding portions 40 are eliminated.

Also in this configuration, the strap 20 can be used as an additional seal between the tray 4 and lid 2 helping to ensure the quality of the product and inform the final consumer that the quality has in fact been maintained. Accordingly, in some embodiments the guiding portion 40 can be positioned near a sealing engagement portion such as a tongue and groove type joint between the lid 2 and tray 4.

With continued reference to FIGS. 1 and 2, the lid 2 has geometry that permits even mating with the tray 4 at their respective peripheral edges (for example with a tongue and groove type joint). The mating between lid 2 and tray 4 can be releasably lockable and can be achieved using a snap-fit grip as best depicted in FIG. 6. As shown, the lid 2 can include a downward-facing opening or groove 36, and the tray 4 can include an upward projection or tongue 37. The opening 36 and the projection 37 can thus be configured to engage together in a snap-fit grip 35 (as depicted in FIG. 6 and further discussed below). The snap-fit grip 35 can form an interference fit between the opening 36 and the projection 37. The snap-fit grip 35 can augment the interference fit by requiring the opening 36 to deflect in a region 38 prior to mounting the projection 37. The deflected opening 36 and similar resulting deflection of the projection 37 can provide a constant normal and frictional force between the opening 36 and projection 37. Similar functionality can also be provided with other geometries, such as an upward facing opening on the tray 4 and a downward facing projection on the lid 2. Further, although the opening 36 and projection 37 are depicted as being substantially angular, in other embodiments they can have smoother surfaces such as a partially circular shape in cross-section. In other embodiments, corresponding notches and grooves can be provided on the projection 37 and opening 36 to provide an enhanced snap-fit between the lid 2 and tray 4.

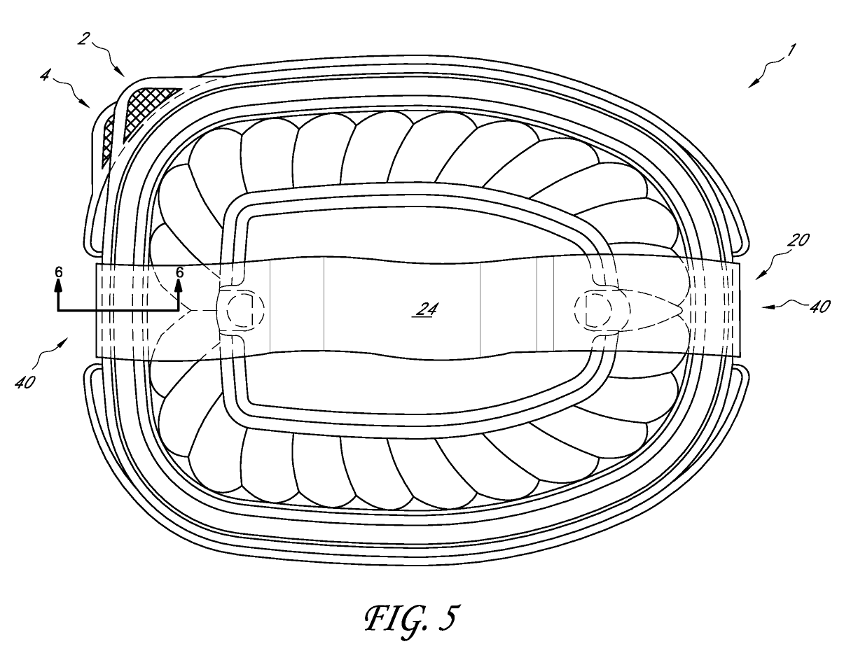

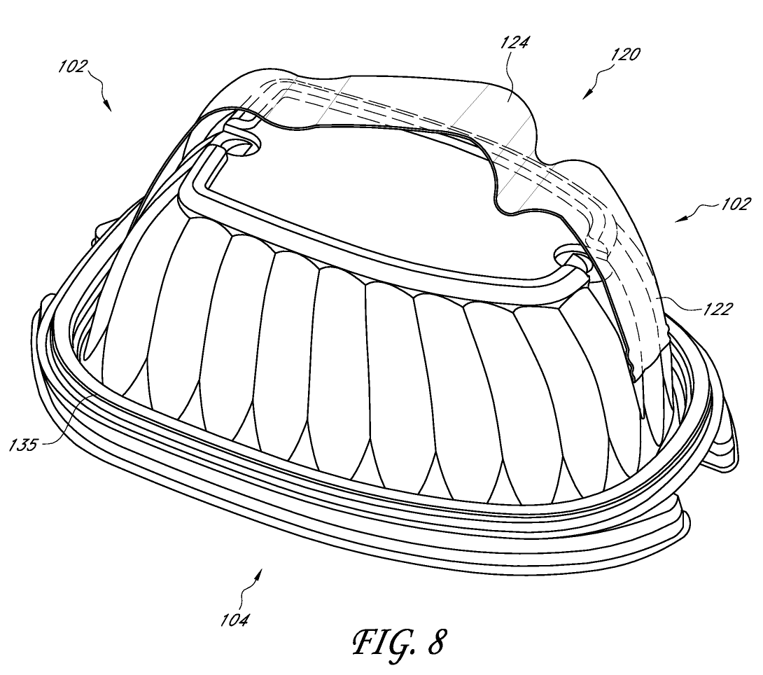

FIG. 6 also demonstrates how a guiding portion 40 can be formed in a tray 4. This sectional view along the 6-6 line of FIG. 5 also shows how the strap 20 can be related to the container system 1 and more particularly to the guiding portion 40. In addition, FIG. 6 shows a difference in size and location of the attachment ends 22 from other illustrated embodiments. As illustrated in FIG. 6, the attachment ends 22 in the illustrated embodiments adhere to the bottom of the tray 4, supporting it from below. As noted above, in other embodiments, another component, such as, for example, plastic tape can be used to secure the attachment ends 22 to the bottom of the tray 4. In other embodiments, one or both ends 22 can be permanently attached to the bottom of the tray 4. In further embodiments, the attachment ends 22 can extend from the bottom of the tray 4 to the lid 2, attaching to both. In further embodiments the strap 20 can attach to a side of the tray 4, or to the lid 2 (as depicted in FIG. 8). As depicted in FIG. 6A, the strap can also attach to both the lid 2 and tray 4 to provide a reliable seal and/or tamper marker, as described above.

FIG. 8, illustrates another embodiment of a container system 101 comprising a strap 120. The food container system 101 may comprise a tray 104 and a lid 102 configured substantially similar to the tray 4 and lid 2 described above. The tray 104 and lid 102 may be connectibly sealed with a tongue and groove type joint 135. The strap 120 comprises attachment ends 122, and a handle 124. The strap 120 may also comprise signage (not shown). The attachment ends 122 are configured to attach to the food container system 101. The handle 124 provides a user a place to hold the container system 101. In this embodiment, the attachment ends 122 are configured to attach to the lid 102 of the food container system 101. In some embodiments, the lid 102 can include flattened portions (not shown) configured to mate with the attachment end 122.

The embodiment of FIG. 8 demonstrates a method to allow the strap 120 to be attached more closely to the center of mass of the container system 101 to increase the ease of use for the user. In other embodiments where the strap 20 attaches to the tray 4, the attachment point may be below the center of mass of the container system 101, making the container system less stable and prone to rotate about the strap 20. Moving the attachment point of the strap 120 to at or above the vertical center of mass of the container system 101 can stabilize the container system 101. This embodiment also shows how the strap 120 can be related to the container system 101 at the lid 102 and it illustrates a difference in size and location of the strap 120 and attachment ends 122 from prior illustrated embodiments. Notably, as depicted the strap 120 connects to the lid 102, which connects to the tray 104 only by the snap-fit grip 135. Thus, the snap-fit grip 135 (as depicted) must support the weight of the tray 104 and the contents the tray holds. Accordingly, depending on the strength of the snap-fit grip 135, this embodiment can be preferably used with low-density products such as cookies, donuts, salads, and cupcakes.

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

In the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

Although certain preferred embodiments and examples are disclosed below, inventive subject matter extends beyond the specifically disclosed embodiments to other alternative embodiments and/or uses of the invention, and to modifications and equivalents thereof. Thus, the scope of the inventions herein disclosed is not limited by any of the particular embodiments described below. For example, in any method or process disclosed herein, the acts or steps of the method or process may be performed in any suitable sequence and are not necessarily limited to any particular disclosed sequence. For purposes of contrasting various embodiments with the prior art, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein. The systems and methods discussed herein can be used anywhere.

What is claimed is:

1. A food container system comprising:
a plastic tray having an upper surface and a lower surface, the upper surface defining a recess for receiving a food item, the recess surrounded by a rim of the plastic tray,
a lid releasably coupled to the tray; and
a flexible strap comprising a handle portion and a first attachment portion and a second attachment portion arranged at opposite ends of the handle portion, the first and second attachment portions coupled to the lower surface of the tray such that the flexible strap extends from one side of the lower surface of the tray over the lid and to another side of the lower surface of the tray.

2. The food container system of claim 1, wherein the tray comprises a grip portion positioned along the rim.

3. The food container system of claim 2, wherein the grip portion includes a channel or opening and the flexible strap, at least partially, passes through the channel or opening in the grip portion.

4. The food container system of claim 3, wherein the lid further comprises a grip portion that corresponds to the grip portion of the tray, the grip portion of the lid also comprising a channel or opening through which the flexible strap, at least partially, passes.

5. The food container system of claim 1, wherein the tray comprises a pair of grip portions positioned along opposite sides of the rim.

6. The food container system of claim 5, wherein each of the grip portions includes a channel or opening and the flexible strap, at least partially extends, through the recess or opening in the handles.

7. The food container system of claim 6, wherein the tray defines a major axis and a minor axis, and the pair of grip portions extending along the major axis.

8. The strap of claim 1, wherein the flexible strap further comprises signage.

9. The container system of claim 1, further comprising a releasably lockable mechanism on at least one of the tray and lid.

10. The container system of claim 9, wherein the releasably lockable mechanism is a snap-fit mechanism.

11. The container system of claim 1, wherein the first and second attachment portions coupled to the lower surface of the tray through an adhesive.

12. The container system of claim 1, wherein the first and second attachment portions coupled to the lower surface of the tray by tape.

13. The container system of claim 1, wherein the first attachment portion is permanently coupled to the lower surface of the tray.

14. The container system of claim 1, wherein the attachment portions comprise an adhesive that adheres to both the tray and lid, and the strap is sufficiently tight between the tray and lid such that the strap will break when attempting to open the container system.

15. The container system of claim 1, wherein the flexible strap is wider at the attachment portions.

16. The container system of claim 1, wherein the flexible strap extends attaches at diagonal ends of the container system.

17. A food container system comprising:
a tray configured to support the entire weight of a contained item;
a lid attached to the tray by a releasably lockable snap-fit grip, the releasably lockable snap-fit grip being strong enough to support the entire weight of the contained item and the tray; and
a flexible strap comprising a handle positioned between two end portions that are coupled to the lid.

18. The container system of claim 17, wherein the strap further comprises signage.

19. The container system of claim 18, further comprising a releasably lockable mechanism on at least one of the tray and lid.

20. The container system of claim 17, wherein the flexible strap is wider at the attachment portions.

21. The container system of claim 17, wherein the flexible strap extends attaches at diagonal ends of the container system.

22. A method of assembling a food container, the method comprising
placing a food item into a recess of a tray portion of the food container;
coupling a lid portion to the tray portion of the food container by engaging the lid and tray in a snap fit to enclose the food item; and
extending a flexible strap over the lid; and
coupling one end the flexible strap to a lower surface of the tray portion to form a handle extending over the lid.

23. The method of claim 22, further comprising coupling a second end of the flexible strap to a lower surface of the tray portion.

24. The method of claim 22, further comprising passing the strap through an aperture or channel formed in the lid or tray portions.
